(19) United States
(12) Patent Application Publication
(10) Pub. No.: US 2015/0049253 A1
(43) Pub. Date: Feb. 19, 2015

(54) Dislike Button and Associated Action on Remote Control

(71) Applicants: Fredrik Persson, Alvsjo (SE); Michail Arman, Bromma (SE); Mats Cedervall, Harnosand (SE)

(72) Inventors: Fredrik Persson, Alvsjo (SE); Michail Arman, Bromma (SE); Mats Cedervall, Harnosand (SE)

(73) Assignee: Telefonaktiebolaget L M Ericsson (publ), Stockholm (SE)

(21) Appl. No.: 14/382,357

(22) PCT Filed: Mar. 2, 2012
(86) PCT No.: PCT/EP2012/053681

§ 371 Date: Sep. 2, 2014

(51) Int. Cl. H04N 5/44; H04N 21/482; H04N 21/475; H04N 21/422; H04N 21/45

(52) U.S. Cl. CPC H04N 5/4403; H04N 21/42204; H04N 21/42222; H04N 21/4532; H04N 21/4756; H04N 21/4826; H04N 2005/4412; H04N 2005/4444
USPC 348/734

(57) ABSTRACT

A method of zapping through a plurality of channels of an electronic device providing content includes: assigning a dislike designation via a wireless transmitter to content being presented on at least one of the channels and skipping the at least one channel during subsequent zapping while the disliked content is being presented on the at least one channel.

### TECHNICAL FIELD

The invention is related to control devices and more particularly to mechanisms for utilizing the control devices to improve zapping through channels.

### BACKGROUND

Control devices, such as remote controllers, are well known. In a typical home entertainment set-up, they are used to control various functions. While using a television, a remote controller can be used to switch on (or switch off) the television. The controller can also be used to increase or decrease the volume as well as change the channel in both ascending (change to the next higher numbered channel) and descending (change to the next lower numbered channel) order. The changing of channels can be referred to as surfing, zapping or hopping through the channels.

The television can receive programming from over the air broadcast channels or from a content provider via a cable (coaxial or fibre optic) or a satellite medium using an intermediate device such as a set-top box. The television can alternatively receive programming over an internet protocol network, such programming may be delivered using HTTP adaptive streaming, and may be accessed by a browser application. The set top box receives the programming from the content provider and provides the programming to a display which may or not have its own programming receiver. The device or set-top box can have a built-in programming receiver. A remote controller can also be used to control this device or set-top box.

As the complexity of integrated home entertainment systems has increased, the number of devices that can be controlled and the functions associated with each of these devices have also increased. It is not unusual for a controller to control the television, set-top box, a CD player, a DVD player, etc.

Mechanisms that improve efficiency in navigating through the ever increasing choices, therefore, are highly desirable.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with an exemplary embodiment, a method of zapping through a plurality of channels of an electronic device providing media content is disclosed. The method comprises: assigning a dislike designation via a wireless transmitter to content being presented on at least one of the channels; and skipping the at least one channel during subsequent zapping while the disliked content is being presented on the at least one channel. The method comprises: assigning a dislike designation via a wireless transmitter to content being presented on at least one of the channels and skipping the at least one channel during subsequent zapping while the disliked content is being presented on the at least one channel.

In accordance with another exemplary embodiment, a system is disclosed. The system comprises an electronic device providing content over a plurality of channels to an output device and a wireless control unit communicating with the electronic device. The wireless control unit (220) has user input interfaces (222, 224, 225) for changing the channels in an ascending order or in a descending order and for assigning a user dislike to content being presented on at least one of the channels. The electronic device skips the at least one channel presenting the disliked content during subsequent changing of the channels while the disliked content continues to be presented on the at least one channel.

In accordance with a further exemplary embodiment, a wireless transmitter for operating an electronic device providing content over a plurality of channels is disclosed. The transmitter comprises: a first user interface for switching channels in an ascending order, a second user interface for switching channels in a descending order, and a third user interface for assigning a user dislike to content being provided by a channel wherein an actuation of the third user interface skips over the channel associated with the disliked content during subsequent switching of channels until an end of presentation of the disliked content.

In accordance with yet another embodiment, a device for receiving media content over a plurality of channels and presenting the content based on user selection of a channel is disclosed. The device comprises: a communication interface and a processor. The interface receives content and user selection commands and presents the content wherein the user commands include commands to: change a channel in an ascending order, change a channel in a descending order and designate content on at least one of the channels as a dislike. The processor skips the at least one channel containing the disliked content during subsequent commands to change channels while the disliked content is being presented on the at least one channel.

### BRIEF DESCRIPTION OF THE DRAWINGS

The objects and advantages of the invention will be understood by reading the following detailed description in conjunction with the drawings in which:

FIG. 1 illustrates a method in accordance with exemplary embodiments;

FIG. 2 illustrates a control unit in accordance with exemplary embodiments;

FIG. 3 illustrates a device in accordance with exemplary embodiments; and

FIG. 4 illustrates a control unit accordance with other exemplary embodiments.

### DETAILED DESCRIPTION

The various features of the invention will now be described with reference to the figures, in which like parts are identified with the same reference characters or numerals.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors).

Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action

In exemplary embodiments, methods, apparatus and systems are disclosed for facilitating improvements and efficiency in the zapping of channels. Users or subscribers to programming from a content provider have access to hundreds or more channels of programming. Given this high number, zapping through the channels can be a time-consuming task. In zapping through the channels, a user may be presented with a particular program on a particular channel. For example, a sporting event may be on channel 902. The user may not be interested in watching in the sporting event. In this case, the user will zap to the next channel (if surfing in ascending order, to channel 903 and beyond for example).

The user may zap through the channels again some time later (in descending order for example) and the sporting event may still be the current programming on channel 902. Since the user had no interest in viewing the sporting event during earlier surfing, the user may not want to see the sporting event. However, in order to get to channel 901, the user has to zap through channel 902 and again be presented with the sporting event (the user can always enter the channel number via the remote controller but this is inefficient compared with zapping through the channels).

As the user zaps through channels, the user may evaluate the programming presented on the channels. The programming may fit into one of three categories to a user for example. The categories may be “like”, “dislike” and “tolerate” for example. Programs in the like category may always be viewed by a user (the user may or will stop zapping through the channels). Programs in the dislike category may never be viewed by a user (the user will always continue zapping to the next channel). Programs in the tolerate category may be acceptable but the user may continue to search for programs in the like category (the user may continue zapping through the channels).

According to exemplary embodiments, a user may communicate a non-preference or “dislike” for programming on a particular channel and this channel may be “skipped over” during subsequent channel zapping. The particular channel may be skipped over until the end of the programming that is designated with the dislike or upon the beginning of a new program.

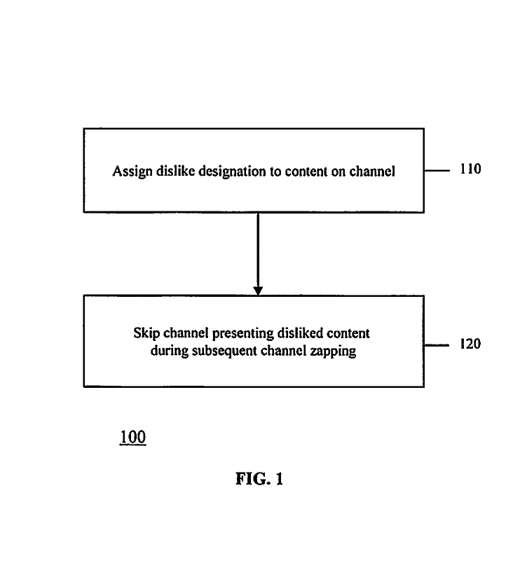

A method in accordance with exemplary embodiments is illustrated in FIG. 1. A user may be zapping through the channels. The programming or content on a particular channel (such as on channel 902 as described above for example) may fall into the dislike category for the user. The user may assign the dislike designation to the content and communicate the dislike designation to a set-top box or television at 110. During subsequent zapping through the channels, the set-top box (or television) may skip over the channel (e.g. channel 902) if the content designated with the dislike is still being presented on that channel at 120. The next channel may be displayed—in the example above, the next channel that is displayed may be channel 903 (if the zapping is in an ascending order) or channel 901 (if the zapping is in a descending order).

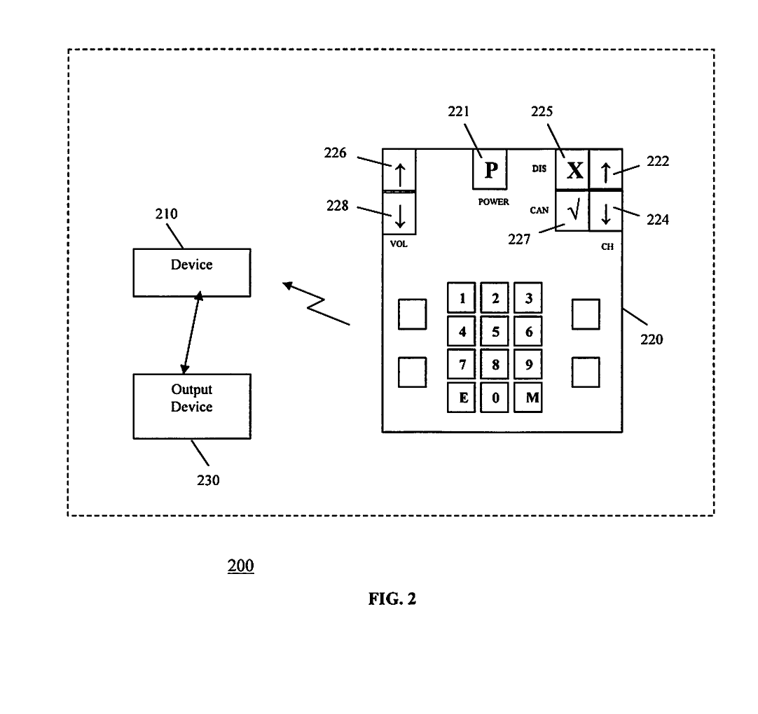

A remote controller is illustrated in FIG. 2. Controller 220 includes a plurality of keys, buttons or user interfaces. Controller 220 may include power button 221, volume buttons 226 and 228, channel buttons 222 and 224 and numerical buttons 0, 1, . . . , 9 (not labeled). The functionality of each of these buttons is known and is not described in further detail. Controller 220 may also include button M for muting and E for entering a selection such as depressing the channel numbers followed by depressing E for example. Additional buttons (illustrated as blank squares and not labeled) can perform other known functions. The buttons may project above a surface of the controller or may be flush with the surface. The buttons may be represented by touch actuated surface.

In exemplary embodiments, controller 220 may include an additional button, key or user interface that may be used for assigning and communicating the dislike designation. In alternative embodiments, an existing button, key or interface on a remote controller may be programmed to facilitate such assignment and communication.

Controller 220 may include dislike button 225 that could be used to assign and communicate the dislike designation to content being provided on a particular channel while the user is zapping through that particular channel. As described in the example, a user may assign a dislike designation to content being provided on channel 902. The user, in the zapping process, “arrives” at channel 902. The user may depress button 225 to assign the dislike designation to the content being provided over that channel.

The dislike designation may be assigned to a particular program. Therefore, upon the end of that program or the beginning of a new program on the “disliked” channel, the dislike designation may be removed by device or set-top box.

In some embodiments, a user may also cancel the dislike designation prior to the end of the program on the particular channel. The user may access the designated channel by directly entering the channel number using the numerical keys (followed by E) and then actuating “cancel” button 227. A user may alternatively cancel the dislike designation by directly entering the channel number using the numerical keys and then actuating the dislike button 225. The cancellation by user may be executed on a channel by channel basis.

Controller 220 may communicate the dislike designation to a device or set-top box 210. In some embodiments, device 210 may display the programming on the various channels; in some embodiments, device 210 may be connected to an output device 230 such as a television or a display or a monitor. Controller 220 may communicate with device 210 via a wireless link such as RF (radio frequency), IR (infrared), Bluetooth or other similar links. Device 210 may be connected to output device 230 via a cable or over a wireless link.

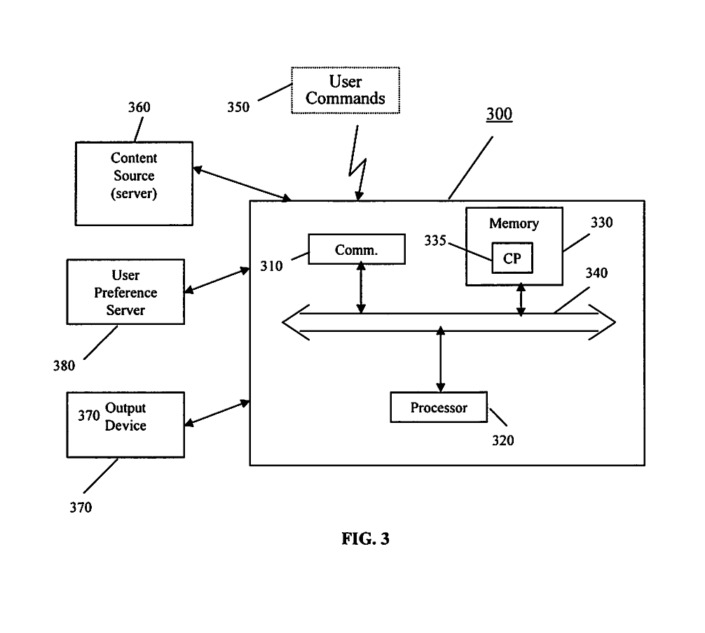

Set-top box 210 of FIG. 2 may be described with reference to FIG. 3. Set-top box 300 may include a communication interface 310, a processor 320 and computer readable medium 330 in the form of memory all of which may be interconnected via bus 340.

Communication interface 310 may receive programming content from a content source or server 360. The communication link between content server 360 and (interface 310 of) set-top box 300 may be via cable, satellite or an IP network. Interface 310 may also receive user commands from a remote controller 350 over a wireless link (RF, IR, Bluetooth, etc.). The programming content may be provided to an output device 370 by set-top box 300 via the communication interface 310.

As described, user commands may include changing the channel in ascending or descending order. User commands may also include assigning a dislike designation to content on at least one of the channels. User commands may further include cancelling the dislike designation as described above.

Processor 320 may evaluate user commands received by interface 310. If the programming content on a channel is assigned with a dislike designation, set-top box skips over this channel during subsequent zapping of the channels by the user commands. This channel will be skipped over until a new program commences on the channel.

Individual programs provided to a set-top box may have an identity (such as a particular code for example). Upon receiving the dislike designation, processor 320 may associate the dislike designation to the program being presented on the current channel. If program ABC is being presented on channel 902 (example above) during zapping of the channels by the user and the user assigns a dislike designation to ABC, processor 320 may associate the dislike to ABC. The channel presenting program ABC (i.e. 902) will be skipped while program ABC is being (or, continues to be) presented on this channel.

User designations may be stored in memory 330 which may also store content recorded by a user for example. In some embodiments, the dislike designation may be communicated by set-top box 300 to content server 360 which may then control the skipping of the designated channel.

In some embodiments, set-top box 300 may also track or accumulate user designations to skip additional channels providing similar programming content. Programs are categorized based on content such as sports, drama, comedy, reality, etc. If a user designates soccer and tennis with a dislike, processor 320 may assign a dislike designation to golf even if the designation for golf was not assigned by the user.

In further embodiments, set-top box may also evaluate user activity to create a user profile. This profile may be utilized to present programs that are likely to be viewed by the user at the beginning of the zapping list. The receiver may maintain a channel mapping table, which maps received channels to a channel number. The channel number may be used by the receiver to arrange an electronic program guide, to allow a user to access a channel by inputting the appropriate channel number, and to form the basis of a zapping list. The channel mapping table may be automatically created during a tuning process, or may be received from a content provider. The user interface of the receiver may facilitate the editing of the channel mapping table. The zapping list may be derived from the channel mapping table. The zapping list may comprise the channels displayed in a different order to the channel mapping table, the order determined by the receiver and using a user profile. The order may be determined by the receiver by using previous viewing activity of the user.

In using controller 200 (of FIG. 2), a user may assign a dislike designation to a channel using button 225 and then resume zapping by using the channel up button 222 or channel down button 224. The channel assigned the dislike designation may, therefore, be displayed until the user actuates one of buttons 222 or 224 to resume zapping. It may be skipped over during subsequent zapping through this channel.

In some embodiments, actuation of the dislike button 225 may register the user preference and the channel may be zapped to the next channel (without actuating button 222 or 224). If the user was zapping in an ascending order, the next channel displayed may be the next higher channel; if the user was zapping in a descending order, the next channel displayed may be the next lower channel. Upon the displaying of the next channel, the user may resume zapping by actuating either button 222 or button 224.

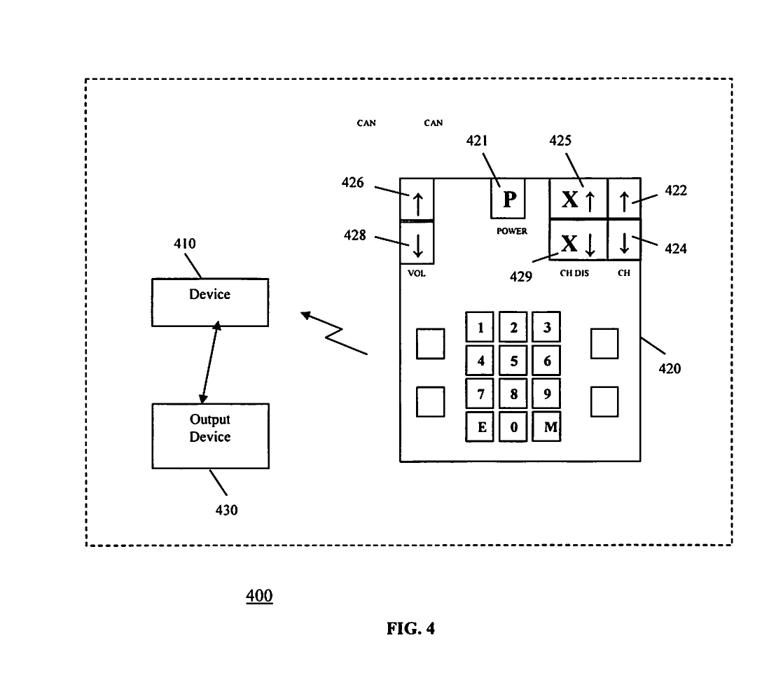

According to some embodiments, the controller may have variable dislike functionality associated with the various buttons or user interfaces. As illustrated in FIG. 4 for example, controller 400 may include buttons 425 and 429. If the user assigns the dislike designation using (channel dislike) button 425, the user preference may be communicated to the set-top box and the next higher channel may be displayed. If a user assigns the dislike designation using (channel dislike) button 429, the user preference may be communicated to the set-top box and the next lower channel may be displayed. Upon the displaying of the next channel, the user may resume zapping by actuating either button 422 or button 424.

A user's preferences such as dislikes may be stored in a location beyond the set-top box. A server location on a network or in the cloud may include memory for storing the user preferences. Referring to FIG. 3, for example, a user preference server 380 may store the user preferences. The user preference server 380 may be connected set-top box 300. The user preference may be updated dynamically or periodically by the set-top box 300. The user preferences may be retrieved by set-top box 300 or by a mobile device or other types of devices that may be used by the user to access programming. The set-top box 300 may maintain the user preferences in a cache even if the preferences are dynamically updated in user preference server 380.

A user may assign a dislike designation to content being presented on more than one channel. The content being presented may be audio or video programming or a combination thereof.

Several advantages may be realized by exemplary embodiments as described. These include, for example, the users having a better zapping experience since the user is more likely and more quickly to find programs that suit the user's preferences.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

1. A method of zapping through a plurality of channels of an electronic device providing content, the method comprising the steps of:
assigning a dislike designation via a wireless transmitter to content being presented on at least one of the channels; and
skipping the at least one channel during subsequent zapping while the disliked content is being presented on the at least one channel.

2. The method of claim 1, further comprising:
including the at least one channel during subsequent zapping if the disliked content is not being presented on the at least one channel.

3. The method of claim 1, further comprising:
accessing the at least one channel while the disliked content is being presented on the at least one channel by entering an identity of the at least one channel via the wireless transmitter.

4. The method of claim 1, further comprising:
detecting patterns in content assigned with the dislike designation;
identifying additional content similar to the disliked content;
skipping at least one additional channel presenting the identified additional content, wherein the additional channel has not been previously presented to a user.

5. A system comprising:
an electronic device for receiving content distributed over a plurality of channels and for providing content distributed over a selected channel to an output device; and
a wireless remote control having user input interfaces for changing the channels in an ascending order or in a descending order and for assigning a user dislike to content being presented on at least one of the channels, wherein the electronic device skips the at least one channel presenting the disliked content during subsequent changing of the channels while the disliked content continues to be presented on the at least one channel and the wireless control unit communicates with the electronic device.

6. The system of claim 5, wherein the wireless control unit is a remote controller.

7. The system of claim 6, wherein the remote controller communicates with the electronic device via one of infrared, radio and Bluetooth signals.

8. The system of claim 5, wherein the electronic device is a television.

9. The system of claim 5, wherein the electronic device is a set top box and the output device is a video monitor.

10. The system of claim 5, wherein the content is at least one of audio content and video content.

11. A wireless transmitter for operating an electronic device providing content over a plurality of channels, comprising:
a first user interface for switching channels in an ascending order;
a second user interface for switching channels in a descending order; and
a third user interface for assigning a user dislike to content being provided by a channel wherein an actuation of the third user interface skips over the channel associated with the disliked content during subsequent switching of channels until an end of presentation of the disliked content.

12. The transmitter of claim 11, wherein the content includes at least one of audio content and video content.

13. The transmitter of claim 11, wherein each of the first, second and third interfaces is on an external surface of the transmitter.

14. The transmitter of claim 13, wherein each of the first, second and third interfaces is a button on an external surface of the transmitter.

15. The transmitter of claim 14, wherein the first and second interfaces are integrated within one button.

16. A device for receiving media content over a plurality of channels and presenting the content based on user selection of a channel, the device comprising:
a communication interface for receiving content and user selection commands and for presenting the content wherein the user commands include commands to: change a channel in an ascending order; change a channel in a descending order; and designate content on at least one of the channels as a dislike; and
a processor for skipping the at least one channel containing the disliked content during subsequent commands to change channels while the disliked content is being presented on the at least one channel.

17. The device of claim 16, wherein the dislike command is received during presentation of the content to the user on the at least one channel.

18. The device of claim 16, wherein the processor removes the dislike designation upon receiving new content on the at least one channel.

19. The device of claim 16, wherein the interface receives commands to remove the dislike designation.

20. The device of claim 16, wherein the content is received from a content server.
